(19) United States
(12) Patent Application Publication
(10) Pub. No.: US 2019/0197926 A1
(43) Pub. Date: Jun. 27, 2019

(54) DISPLAY DEVICE AND INTELLIGENT FLOOR

(71) Applicant: BOE TECHNOLOGY GROUP CO., LTD., Beijing (CN)

(72) Inventors: Xinguo Li, Beijing (CN); Wenbo Li, Beijing (CN)

(21) Appl. No.: 15/751,320

(22) PCT Filed: Jul. 17, 2017
(86) PCT No.: PCT/CN2017/093211

§ 371 Date: Feb. 8, 2018

(30) Foreign Application Priority Data
Oct. 18, 2016 (CN) 201621134668.6

(51) Int. Cl. G09F 19/12; G09F 19/18; G02B 5/08

(52) U.S. Cl. CPC G09F 19/12; G02B 5/085; G02B 5/0808; G09F 19/18

(57) ABSTRACT

A display device and an intelligent floor are disclosed. The display device comprises a first image display part and a second image display part, the first image display part being connected with the second image display part, wherein the first image display part is configured to provide a virtual image at a side of the second image display part through the second image display part.

### CROSS-REFERENCE TO RELATED APPLICATION

This application is a Section 371 National Stage Application of International Application No. PCT/CN2017/093211, filed on Jul. 17, 2017, entitled “DISPLAY DEVICE AND INTELLIGENT FLOOR”, which claims priority to Chinese Application No. 201621134668.6, filed on Oct. 18, 2016, incorporated herein by reference in their entirety.

### TECHNICAL FIELD

The present application relates to the field of display technology, and particularly to a display device and an intelligent floor.

### BACKGROUND

With development of social economy and culture, more and more customers seek visual enjoyments, and image floating technologies have been widely used in many fields. When a user is watching an image displayed by a display device, the user may have a feel that the image is floating in the air (in fact, the image that the user is watching is a virtual image).

Prior art display device having a floating display function needs a base supporting part for supporting the display device, and connection relation between display parts thereof and positions of the display parts are fixed.

### SUMMARY

Embodiments of the present disclosure provide a display device, which comprises a first image display part and a second image display part, the first image display part being connected with the second image display part, wherein the first image display part is configured to provide a virtual image at a side of the second image display part through the second image display part.

In at least one embodiment, the first image display part and the virtual image are located at two opposite sides of the second image display part.

In at least one embodiment, the first image display part comprises a display screen or a projector.

In at least one embodiment, the second image display part comprises a reflective structure.

In at least one embodiment, the reflective structure is a totally reflective structure.

In at least one embodiment, the second image display part comprises a transflective layer.

In at least one embodiment, the second image display part comprises a transflective layer and a third image display part arranged successively and superposed with each other in a direction facing away from the first image display part.

In at least one embodiment, the third image display part comprises a non-transparent display screen.

In at least one embodiment, the transflective layer is formed of a non-continuous reflective film.

In at least one embodiment, the reflective film is an aluminum film or a tin film.

In an embodiment, the transflective layer is formed of a composite film having a plurality of layers.

In at least one embodiment, the transflective layer is formed of a transflective liquid crystal film.

In at least one embodiment, the first image display part is movably connected with the second image display part.

In at least one embodiment, each of the first image display part and the second image display part has a plate-shaped structure; and a first end of the first image display part and a first end of the second image display part are connected together by a pivot shaft.

In at least one embodiment, a second end of the first image display part and a second end of the second image display part are provided respectively with magnets or snap fasteners that are complementary in shape; and the magnets or snap fasteners are configured to connect the second end of the first image display part with the second end of the second image display part.

In at least one embodiment, the display device further comprises an elastic member connected with the first image display part and the second image display part, the elastic member is configured such that the first image display part and the second image display part form a preset angle therebetween when the second end of the first image display part is disconnected from the second end of the second image display part.

In at least one embodiment, each of the first image display part and the second image display part has a plate-shaped structure; a first end of the first image display part and a first end of the second image display part are connected together through an opening fixing element, which is configured to maintain a preset angle between the first image display part and the second image display part.

In at least one embodiment, the preset angle is 45 degrees.

Embodiments of the present disclosure further provide an intelligent floor, which comprises: the display device according to any one of the above embodiments; and a transparent floor, wherein the first image display part and the second image display part are located at a same side of the transparent floor.

### BRIEF DESCRIPTION OF THE DRAWINGS

In order to more clearly illustrate the technical solutions in embodiments of the present application, a brief introduction to the drawings that are used to describe the embodiments is provided as follows. Apparently, the appended drawings only show a part of embodiments of the present application, other drawings can be obtained by those ordinary skilled in the art based on the appended drawings without any creative work.

FIG. 1 is an illustrative structural drawing showing a display device according to an embodiment of the present application;

FIG. 2 is an illustrative structural drawing showing another display device according to an embodiment of the present application;

FIG. 3 is an illustrative structural drawing showing another display device according to an embodiment of the present application;

FIG. 4 is an illustrative structural drawing showing another display device according to an embodiment of the present application;

FIG. 5 is an illustrative structural drawing showing an intelligent floor according to an embodiment of the present application;

FIG. 6 is an illustrative structural drawing showing another intelligent floor according to an embodiment of the present application;

FIG. 7 shows an example of a second image display part in a display device according to an embodiment of the present application; and

FIG. 8 shows another example of a second image display part in a display device according to an embodiment of the present application.

### DETAILED DESCRIPTION OF EMBODIMENTS

In order to make the objects, technical solutions and advantages of the present application more apparent, embodiments of the present application will be described in detail with reference to the accompanying drawings.

In the process of making the present application, the inventors of the present application found that prior arts have at least the following problems: an existing display device needs a support base, a structure thereof is complicated, and orientations of display parts thereof cannot be flexibly adjusted.

According to a general inventive concept, an embodiment of the present application provides a display device, which comprises: a first image display part and a second image display part, the first image display part is connected with the second image display part; the first image display part is configured to provide a virtual image at a side of the second image display part through the second image display part.

To be noted, in the following detailed description, for the sake of simplifying explanations, many details are set forth to provide a thorough understanding of embodiments of the present disclosure. Apparently, however, one or more embodiments can be implemented without these details. In order cases, well-known structures and means are schematically shown so as to simplify the drawings.

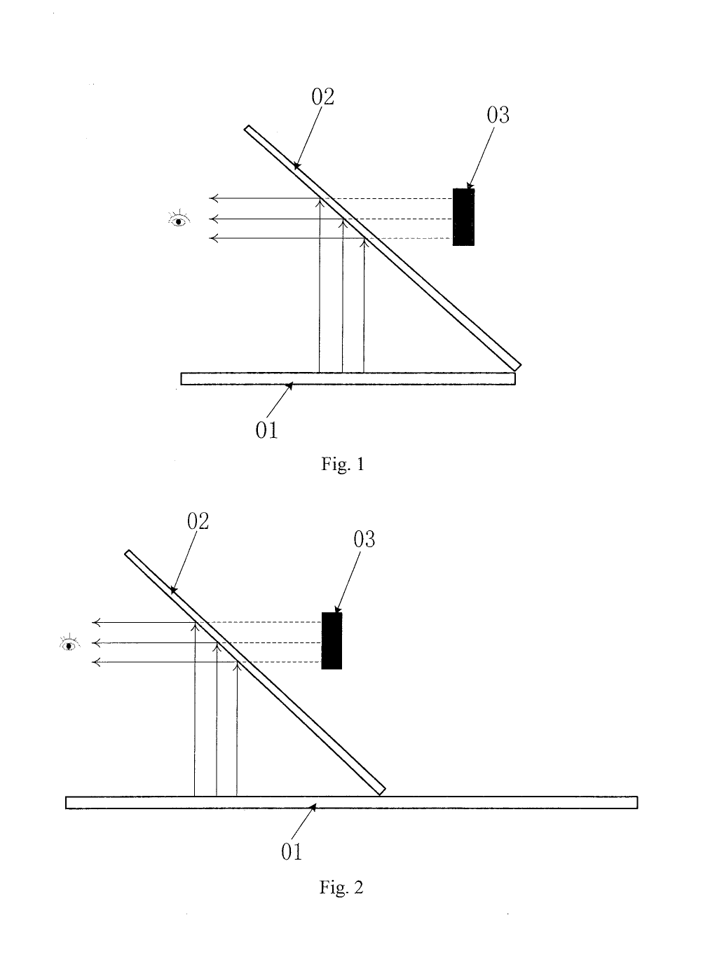

FIG. 1 is an illustrative structural drawing showing a display device according to an embodiment of the present application. The display device comprises:

a first image display part 01 and a second image display part 02, the first image display part 01 being connected with the second image display part 02.

The first image display part 01 is configured to provide a virtual image 03 at a side of the second image display part 02 through the second image display part 02.

As an example, the first image display part 01 and the virtual image 03 may be located at two opposite sides of the second image display part 02 respectively.

FIG. 1 shows a case where the first image display part 01 and the second image display part 02 are connected to form a V-shaped structure. In a practical application, please refer to FIG. 2, which shows a structure of another display device according to an embodiment of the present application, wherein the connected first image display part 01 and second image display part 02 may not form a V-shaped structure.

In summary, in the display device provided in the embodiment of the present application, by connecting the first image display part with the second image display part, an image displayed by the first image display part may form a virtual image at a side of the second image display part without any base being used as a support for the first image display part and the second image display part, such that a structure of the display device is simplified.

Optionally, as shown in FIG. 1, the first image display part 01 may be a display screen or a projector. For example, the display screen may be any one of a light-emitting diode (LED) screen, an organic light-emitting diode (OLED) screen, a plasma display panel (PDP) screen and a liquid crystal display (LCD) screen.

In a practical application, the function of the second image display part 02 may be realized by various structures.

In at least one embodiment of the present disclosure, as shown in FIG. 1, the second image display part 02 may comprises a transflective layer, and when the second image display part 02 comprises the transflective layer, the transflective layer can reflect a part of light emitted by the first image display part 01, and transmit another part of the light therethrough. When a user is watching, he/she may see a floating image reflected by the transflective layer, and the floating image is the virtual image 03.

In at least one embodiment of the present disclosure, the second image display part 02 may comprises a reflective structure, and when the second image display part 02 comprises the reflective structure, it can reflect light emitted by the first image display part 01. For example, the reflective structure may only allow light to be reflected and does not allow light to be transmitted therethrough. As an example, the reflective structure may be a totally reflective structure.

In the embodiment of the present application, when the second image display part 02 comprises the reflective structure, light emitted by the first image display part 01 can be reflected by the second image display part 02 but cannot be transmitted therethrough. Therefore a visual effect is better when a user is watching the image displayed by the display device. In a practical application, the reflective structure may be a flat mirror.

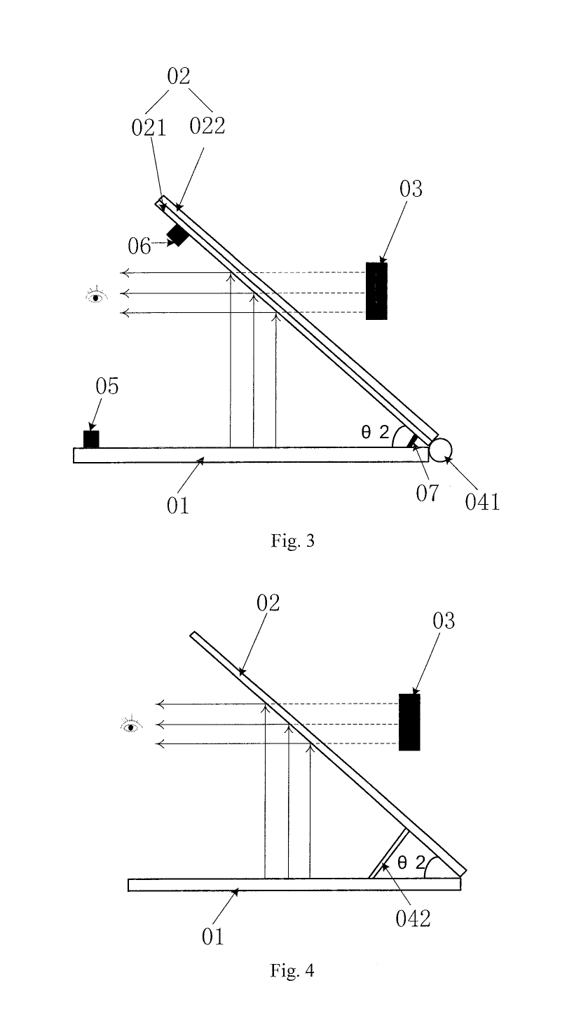

FIG. 3 is an illustrative structural drawing showing another display device according to an embodiment of the present application, wherein the second image display part 02 may comprises a transflective layer 021 and a third image display part 022 arranged successively and superposed with each other in a direction facing away from the first image display part 01. For example, the transflective layer 021 may be adhered to a surface of the third image display part 022.

In an embodiment of the present application, the third image display part 022 may be a non-transparent display screen. As an example, an image displayed by the third image display part 022 may be different from an image displayed by the first image display part 01. For example, the image displayed by the third image display part 022 may form a contrast to a floating image generated by the light emitted by the first image display part 01 and reflected by the transflective layer 021, and the images can be combined together artfully, such that a floating effect of the image can be more apparent and more real when it is watched by a user. For example, when the image displayed by the first image display part 01 is a bird flapping its wings, the third image display part 022 may display an image of the sky, and in this condition, the user may see a floating image of a bird flying in the sky. Since the image displayed by the third image display part 022 is used as a contrast, the floating effect of the floating image seen by the user can be more apparent and real.

Exemplarily, the third image display part 022 may also be a transparent display screen. When the third image display part 022 is a transparent display screen and the image displayed by the third image display part 022 and the image displayed by the first image display part 01 are the same, the user may not only see a combined image displayed by the first image display part 01 and the third image display part 022, but also see a real object located behind the second image display part 02 (i.e., at the right side of the second image display part 02 in FIG. 3), therefore an effect of interacting between virtuality and reality can be achieved skillfully. For example, the image displayed by the first image display part 01 is an image of a group of sheep, the image displayed by the third image display part 022 is a grassland, and in this circumstance, when a user watches the second image display part 02 from a front side thereof (i.e., the left side of the second image display part 02 in FIG. 3), he/she can see a floating image in which the group of sheep is in the grassland, and when the user is located behind the second image display part 02, a photo of the user being in the grassland may be taken from the front side of the second image display part 02, such that the photo is more real, and user experience is improved.

In a practical application, the image displayed by the third image display part 022 and the image displayed by the first image display part 01 may be the same; or the third image display part 022 may not display any image, and when the third image display part 022 does not display any image, the second image display part 02 is equivalent to a mirror reflection structure.

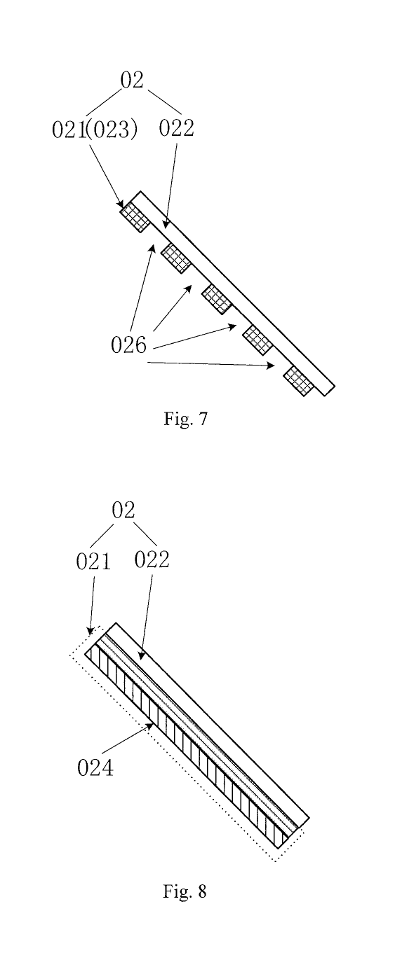

In embodiments of the present application, the transflective layer may be realized in various ways. As shown in FIG. 7, in at least one embodiment of the present disclosure, the transflective layer 021 is formed by a non-continuous reflective film 023. The reflective film 023 may be, for example, an aluminium film or a tin film. For example, a plurality of transmissive spots 026 may be provided in the aluminium film or the tin film, and light may pass through the aluminium film or the tin film through these transmissive spots 026, such that the transflective layer formed by the reflective film 023 can not only allow light to pass therethrough but also reflect light. As an example, the aluminium film or the tin film may be formed through a plating process. In a practical application, a non-continuous aluminium film or a non-continuous tin film may be formed on the third image display part 022 by an evaporation device through a vapor deposition process.

In at least one embodiment of the present disclosure, as shown in FIG. 8, the transflective layer 021 may be a composite film 024 having a plurality of layers. FIG. 8 shows a two-layer structure, however, it is just illustrative. In embodiments of the present application, the composite film 024 may have more than two layers. For example, the composite film 024 having multiple layers (at least two layers) may be an advanced polarizer film (APF) having a plurality of layers, which are usually adhered to an absorptive polarizer. As an example, the transflective layer may be a liquid crystal film.

As an example, the first image display part 01 is movably connected to the second image display part 02, so as to achieve an adjustment of positions of display parts. In a practical application, the movable connection between the first image display part 01 and the second image display part 02 can be realized in various ways.

In at least one embodiment of the present disclosure, please refer to FIG. 3, in which each of the first image display part Oland the second image display part 02 may be a plate-shaped structure. For example, the first image display part 01 may be a plate-shaped display screen, or a display screen provided on a plate-shaped mount or the like; the second image display part 02 is a plate-shaped display screen, or a display screen provided on a plate-shaped mount, or a plate-shaped transflective layer, or a plate-shaped mirror or the like; a first end of the first image display part 01 and a first end of the second image display part 02 are movably connected together through a pivot shaft 041, a second end of the first image display part 01 is provided with a first element 05, a second end of the second image display part 02 is provided with a second element 06, and the first element 05 and the second element 06 may be magnets or snap fasteners that are complementary in shape. With the magnets or snap fasteners, the second end of the first image display part 01 and the second end of the second image display part 02 can be connected together. For example, when the display device is not being used, the first image display part 01 and the second image display part 02 may be folded together, such that the display device can be thinner, and the display device can be protected, and the display device would be easy to be carried when it has a small volume. For example, when both of the first element 05 and the second element 06 are magnets, and the first element 05 is used as a north polar (i.e., the N polar) magnet, and the second element 06 is used as a south polar (i.e., the S polar) magnet, the first element 05 and the second element 06 can be connected together, such that the first image display part 01 and the second image display part 02 can be further fastened together.

In an embodiment of the present application, please refer to FIG. 3, the display device further comprises an elastic member 07, which is connected with the first image display part 01 and the second image display part 02, and when the first element 05 and the second element 06 are disconnected, the elastic member 07 causes the first image display part 01 and the second image display part 02 to be separated to have a preset angle θ2 therebetween. Exemplarily, as shown in FIG. 3, the elastic member 07 may be disposed between the first image display part 01 and the second image display part 02, and the elastic member 07 may be a compression spring.

In another way of realization, please refer to FIG. 4 which shows a structure of another display device according to an embodiment of the present application, each of the first image display part 01 and the second image display part 02 may be a plate-shaped structure; the first end of the first image display part 01 and the first end of the second image display part 02 are connected together through an opening fixing element 042, the opening fixing element 042 can hold the first image display part 01 and the second image display part 02 such that the preset angle θ2 is maintained between the first image display part 01 and the second image display part 02. The opening fixing element 042 may be constructed in a principle of joint mechanism. In the display device, the opening fixing element 042 acts as a “joint”, the first image display part 01 and the second image display part 02 acts as “bones” pivoting about the “joint”, the first image display part 01 and the second image display part 02 are rotatable about the opening fixing element 042, and when they stop rotating, their positions are fixed, the opening fixing element 042 can set the included angle θ2 between the first image display part 01 and the second image display part 02 to be any one of several given degrees (including a preset degree and 0 degree), or any degree.

In a practical application, the opening fixing element may also be a stepless opening fixing element, which can fix the first image display part and the second image display part with any included angle between the first image display part and the second image display part. For example, the stepless opening fixing element may be a hinge, for example, a two-piece hinge.

When using the display device, the opening fixing element 042 may fix the first image display part 01 and the second image display part 02, or set the included angle between the first image display part 01 and the second image display part 02 to be a preset angle, such that a user may see a floating image; when the display device is not used, the first image display part 01 and the second image display part 02 can be folded together, so that the display device can be protected.

As an example, please refer to FIG. 3 or FIG. 4, the preset degree is 45 degrees. When the included angle θ2 between the first image display part 01 and the second image display part 02 is 45 degrees, a sight line of the user needs to be parallel to the direction of the first image display part 01 to see the floating image; when the included angle θ2 between the first image display part Oland the second image display part 02 has another degree, the user needs to look up or look down to see the floating image.

In summary, in the display device provided in the embodiments of the present application, with the first image display part and the second image display part being connected together, the image displayed by the first image display part may form a virtual image at a side of the second image display part, without using any base as a support for the first image display part and the second image display part, such that the structure of the display device is simplified. At the same time, since the first image display part and the second image display part are movably connected, orientations of the display parts can be adjusted flexibly. When the second image display part is a reflective structure or is consisted of a transflective layer and a third image display part disposed successively, a floating effect of the floating image displayed by the display device can be more apparent.

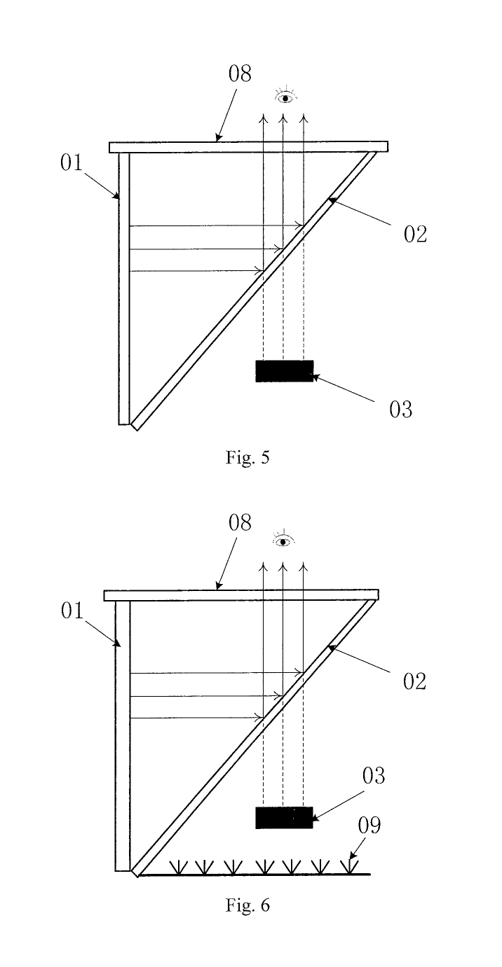

FIG. 5 is an illustrative structural drawing showing an intelligent floor according to an embodiment of the present application, which comprises the display device described above and a transparent floor 08.

The first image display part 01 provides a virtual image 03 at a side of the second image display part 02 through the second image display part 02.

The first image display part 01 and the second image display part 02 are located at the same side of the transparent floor 08.

FIG. 5 shows that the transparent floor 08 may be disposed perpendicular to the direction of gravity, and that the transparent floor 08, the first image display part 01 and the second image display part 02 form a triangular structure. In a practical application, the transparent floor 08 may also be inclined (i.e., not perpendicular to the direction of gravity), and the transparent floor 08, the first image display part 01 and the second image display part 02 may not form a closed shape.

As an example, the second image display part 02 may include a transflective layer. When using the transflective layer as the second image display part 02, a user can not only see a floating image displayed by the intelligent floor, but also see a view underneath the intelligent floor. For example, please refer to FIG. 6, which is an illustrative structural drawing showing another intelligent floor according to an embodiment of the present application, some grass 09 may be planted underneath the intelligent floor, the image displayed by the first image display part 01 may be a swimming fish, such that the user may see a floating image (i.e., the virtual image 03) of the swimming fish and the grass 09 planted on the ground at the same time. Moreover, the user may obtain a visual illusion that the fish is swimming in the grass.

The embodiments of the present application may provide the following exemplary beneficial effects:

With the first image display part and the second image display part being connected together, the image displayed by the first image display part may form a virtual image at a side of the second image display part, without using any base as a support for the first image display part and the second image display part, such that the structure of the display device is simplified. At the same time, since the first image display part and the second image display part are movably connected, orientations of the display parts can be adjusted flexibly. When the second image display part is a reflective structure or is consisted of a transflective layer and a third image display part disposed successively, a floating effect of the floating image displayed by the display device can be more apparent.

In summary, the display device provided in the embodiments of the present application can be used in an intelligent floor, such that the intelligent floor may generate a floating image, the floor is provided with an enriched function and user experience is improved.

The above only describes some preferable embodiments of the present application, which are not intended to limit the present application. Modifications, substitutions and improvements made without departing from the spirit and principle of the present application shall fall within the scope of the present application.

1. A display device, comprising:
a first image display part and a second image display part, the first image display part being connected with the second image display part,
wherein the first image display part is configured to provide a virtual image at a side of the second image display part through the second image display part.

2. The display device according to claim 1, wherein the first image display part and the virtual image are located at two opposite sides of the second image display part.

3. The display device according to claim 1, wherein
the first image display part comprises a display screen or a projector.

4. The display device according to claim 1, wherein
the second image display part comprises a reflective structure.

5. The display device according to claim 4, wherein
the reflective structure is a totally reflective structure.

6. The display device according to claim 1, wherein
the second image display part comprises a transflective layer.

7. The display device according to claim 1, wherein
the second image display part comprises a transflective layer and a third image display part arranged successively and superposed with each other in a direction facing away from the first image display part.

8. The display device according to claim 7, wherein
the third image display part comprises a non-transparent display screen.

9. The display device according to claim 6, wherein
the transflective layer is formed of a non-continuous reflective film.

10. The display device according to claim 9, wherein
the reflective film is an aluminum film or a tin film.

11. The display device according to claim 6, wherein
the transflective layer is formed of a composite film having a plurality of layers.

12. The display device according to claim 6, wherein
the transflective layer is formed of a transflective liquid crystal film.

13. The display device according to claim 1, wherein
the first image display part is movably connected with the second image display part.

14. The display device according to claim 13, wherein
each of the first image display part and the second image display part has a plate-shaped structure; and
a first end of the first image display part and a first end of the second image display part are connected together by a pivot shaft.

15. The display device according to claim 14, wherein
a second end of the first image display part and a second end of the second image display part are provided respectively with magnets or snap fasteners that are complementary in shape; and
the magnets or snap fasteners are configured to connect the second end of the first image display part with the second end of the second image display part.

16. The display device according to claim 15, wherein
the display device further comprises an elastic member connected with the first image display part and the second image display part, the elastic member is configured such that the first image display part and the second image display part form a preset angle therebetween when the second end of the first image display part is disconnected from the second end of the second image display part.

17. The display device according to claim 13, wherein
each of the first image display part and the second image display part has a plate-shaped structure; a first end of the first image display part and a first end of the second image display part are connected together through an opening fixing element, which is configured to maintain a preset angle between the first image display part and the second image display part.

18. The display device according to claim 16, wherein
the preset angle is 45 degrees.

19. An intelligent floor, comprising:
the display device according to claim 1; and
a transparent floor,
wherein the first image display part and the second image display part are located at a same side of the transparent floor.
